(19) United States
(12) Patent Application Publication
(10) Pub. No.: US 2008/0288869 A1
(43) Pub. Date: Nov. 20, 2008

(54) Boolean Search User Interface

(75) Inventor: Randy Ubillos, Los Altos, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/185,022

(22) Filed: Aug. 1, 2008

Related U.S. Application Data
(63) Continuation-in-part of application No. 11/760,631, filed on Jun. 8, 2007.
(60) Provisional application No. 60/871,740, filed on Dec. 22, 2006.

(51) Int. Cl. G06F 3/048

(52) U.S. Cl. 715/716

(57) ABSTRACT

A computer implemented method includes displaying a plurality of keywords, each keyword being associated with one or more media items and a Boolean operation tool comprising an inclusion selector and an exclusion selector. The method also includes receiving a selection of either the inclusion selector or the exclusion selector for one or more of the associated keywords, filtering the media items based on the one or more selected selectors, and displaying the filtered media items. Media items can include, for example, video clips, segments of video clips, and digital still images.

### CROSS REFERENCE TO RELATED APPLICATION

This application is a continuation-in-part of U.S. patent application Ser. No. 11/760,631 filed on Jun. 8, 2007, which application claims the benefit of the filing date of U.S. Provisional Application Ser. No. 60/871,740, filed on Dec. 22, 2006, and entitled “Two-Dimensional Timeline.” The entire disclosure of U.S. patent application Ser. No. 11/760,631 filed on Jun. 8, 2007 and of U.S. Provisional Application Ser. No. 60/871,740 filed on Dec. 22, 2006 are incorporated herein by reference.

### TECHNICAL FIELD

In general, this document describes systems and techniques for editing video clips using video editing software.

### BACKGROUND

Scenes in motion can be captured and recorded using a variety of devices ranging from state-of-the-art professional video cameras used in television and moviemaking to simple cameras on cellular telephones. Some of the devices that can be used to capture motion pictures, including digital camcorders and digital cameras, also allow storing the captured images in digital format including the moving picture experts group (MPEG) format. Depending on device capabilities and user settings, a camera can capture and store both audio and video. The recorded information is automatically stored in digital format and can be easily transported to secondary devices including hard disks in computers using various wired or wireless communications protocols such as Bluetooth or universal serial bus (USB) based devices.

Video editing software provides a user in possession of a large repository of video clips with non-linear editing techniques to edit raw footage. Such editing includes cutting segments of the footage, re-arranging segments of the same video clip, re-arranging and combining segments of multiple video clips, and categorizing segments of video clips by associating keywords to one or more segments. Software manufacturers regularly add features to the software so that the software is simple to operate for an average user, while providing a near-professional quality to the finished video.

### SUMMARY

In one example, a user can display media items (e.g. video clips, photographs, audio clips, and the like) having associated keywords and filter the display to view all or segments of media items based on one or more keywords assigned to the one or more segments of the media items

In one aspect, a computer implemented method is described. The method includes displaying a plurality of keywords, each keyword being associated with one or more media items and a Boolean operation tool including an inclusion selector and an exclusion selector; receiving a selection of either the inclusion selector or the exclusion selector for one or more of the associated keywords; filtering the media items based on the one or more selected selectors; and displaying the filtered media items.

This, and other aspects, can include one or more of the following features. Assigning the keyword includes enabling a user to first select the segment of the thumbnail group and enabling the user to then activate the tool to associate the keyword to the selected segment. Displaying a Boolean AND operation selector, receiving a selection of the Boolean AND operation selector, and wherein the filtering includes allocating the media items for display that have all the keywords for which the inclusion selector is selected. Displaying a Boolean OR operation selector, receiving a selection of the Boolean OR operation selector, and wherein the filtering includes allocating the media items for display that have any of the keywords for which the inclusion selector is selected. Filtering includes excluding from display any of the media items that have any of the keywords for which the exclusion selector is selected. The displaying the filtered media items includes displaying a thumbnail. The media items include segments of a video clip.

Other aspects can include one or more of the following features. Displaying the filtered media items includes displaying thumbnails of the segments and hiding the filtered-out segments. Also, enabling a user to add one or more of the filtered segments to a project pane. Determining which segments are shaky and automatically assigning a keyword to the shaky segments. Determining which segments are shaky includes determining which segments have excessive shake and which segments have low shake. One or more of media items include a digital still image. One of the keywords is associated with more than one of the media items. One of the media items has multiple associated keywords.

In another aspect, a computer program product embodied on a computer-readable medium, operable to cause a data processing apparatus to perform operations including displaying a plurality of keywords, each keyword being associated with one or more media items and a Boolean operation tool including an inclusion selector and an exclusion selector; receiving a selection of either the inclusion selector or the exclusion selector for one or more of the associated keywords; filtering the media items based on the one or more selected selectors; and displaying the filtered media items.

This, and other aspects, can include one or more of the following features. The computer program product further operable to cause a data processing apparatus to perform operations including displaying a Boolean AND operation selector; receiving a selection of the Boolean AND operation selector; and wherein the filtering includes allocating the media items for display that have all the keywords for which the inclusion selector is selected. The computer program product further operable to cause a data processing apparatus to perform operations including displaying a Boolean OR operation selector; receiving a selection of the Boolean OR operation selector; and wherein the filtering includes allocating the media items for display that have any of the keywords for which the inclusion selector is selected. Filtering includes excluding from display any of the media items that have any of the keywords for which the exclusion selector is selected. Displaying the filtered media items includes displaying a thumbnail.

Other aspects can include one or more of the following features. The media items include segments of a video clip. The displaying the filtered media items include displaying thumbnails of the segments and hiding the filtered-out segments. The computer program product further operable to cause a data processing apparatus to perform operations including enabling a user to add one or more of the filtered segments to a project pane. The computer program product further operable to cause a data processing apparatus to perform operations including determining which segments are shaky; and automatically assigning a keyword to the shaky segments. Determining which segments are shaky includes determining which segments have excessive shake and which segments have low shake. One or more of media items include a digital still image. One of the keywords is associated with more than one of the media items. One of the media items has multiple associated keywords.

In another aspect, a system is described. The system includes computer-readable medium configured to store one or more media items; a display; a user-interface device configured to receive input from a user; and processor electronics configured to perform the functions including displaying on the display a plurality of keywords, each keyword being associated with the one or more media items and a Boolean operation tool including an inclusion selector and an exclusion selector; receiving from the user-interface device a selection of either the inclusion selector or the exclusion selector for one or more of the associated keywords; filtering the media items based on the one or more selected selectors; and displaying on the display the filtered media items.

This, and other aspects, can include one or more of the following features. The processor electronics are further configured to perform the functions including displaying on the display a Boolean AND operation selector; receiving from the user interface device a selection of the Boolean AND operation selector; and wherein the filtering includes allocating the media items for display that have all the keywords for which the inclusion selector is selected. The processor electronics are further configured to perform the functions including displaying on the display a Boolean OR operation selector; receiving from the user interface device a selection of the Boolean OR operation selector; and wherein the filtering includes allocating the media items for display that have any of the keywords for which the inclusion selector is selected. The displaying the filtered media items includes displaying a thumbnail.

Other aspects can include one or more of the following features. The media items include segments of a video clip. The displaying the filtered media items includes displaying thumbnails of the segments and hiding the filtered-out segments. The processor electronics are further configured to perform the function including enabling a user to add one or more of the filtered segments to a project pane. The processor electronics are further configured to perform the functions including determining which segments are shaky; and automatically assigning a keyword to the shaky segments. Determining which segments are shaky includes determining which segments have excessive shake and which segments have low shake. One or more of media items include a digital still image. One of the keywords is associated with more than one of the media items. One of the keywords is associated with more than one of the media items.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B depict an example of a system for performing video editing.

FIG. 2A is an example of a schematic of a user interface displaying each video clip as a thumbnail.

FIG. 2B is an example of a schematic of a user interface displaying a video clip as a thumbnail group.

FIG. 3 is an example of a schematic of a user interface displaying a plurality of video clips as corresponding thumbnail groups.

FIG. 4A is an example of a schematic of a user interface displaying tools to assign keywords to video clips.

FIG. 4B is an example of a schematic of a user interface displaying tools to assign keywords to video clips.

FIG. 5 is an example of a schematic of a user interface displaying tools to assign keywords to video clips.

FIG. 6 is an example of a schematic of a user interface displaying tools to filter the display based on keywords.

FIG. 7A is an example of a schematic of a user interface displaying tools to filter the display based on keywords.

FIG. 7B is an example of a schematic of a user interface displaying tools to filter the display based on keywords.

FIG. 7C is an example of a schematic of a user interface displaying tools to filter the display based on keywords.

FIG. 8 is a flowchart of an example of assigning a keyword to segments of video clips.

FIG. 9 is a flowchart of an example of assigning a keyword in a keyword palette to segments of video clips.

FIG. 10 is a flowchart of an example of filtering the display of segments of video clips based on keywords.

FIG. 11 depicts a flowchart of an example of filtering the display of media items based on keywords using INCLUDE and EXCLUDE buttons.

FIG. 12 depicts a flowchart of an example of assigning keywords and filtering media items based on those keywords.

FIGS. 13A,13B, and 13C depict flowcharts of examples of filtering media items.

FIG. 14 is an example of a schematic of a system on which the video editing software is implemented.

FIG. 15 is an example of a schematic of a central processing unit.

Like reference symbols in the various drawings indicate like elements.

### DETAILED DESCRIPTION

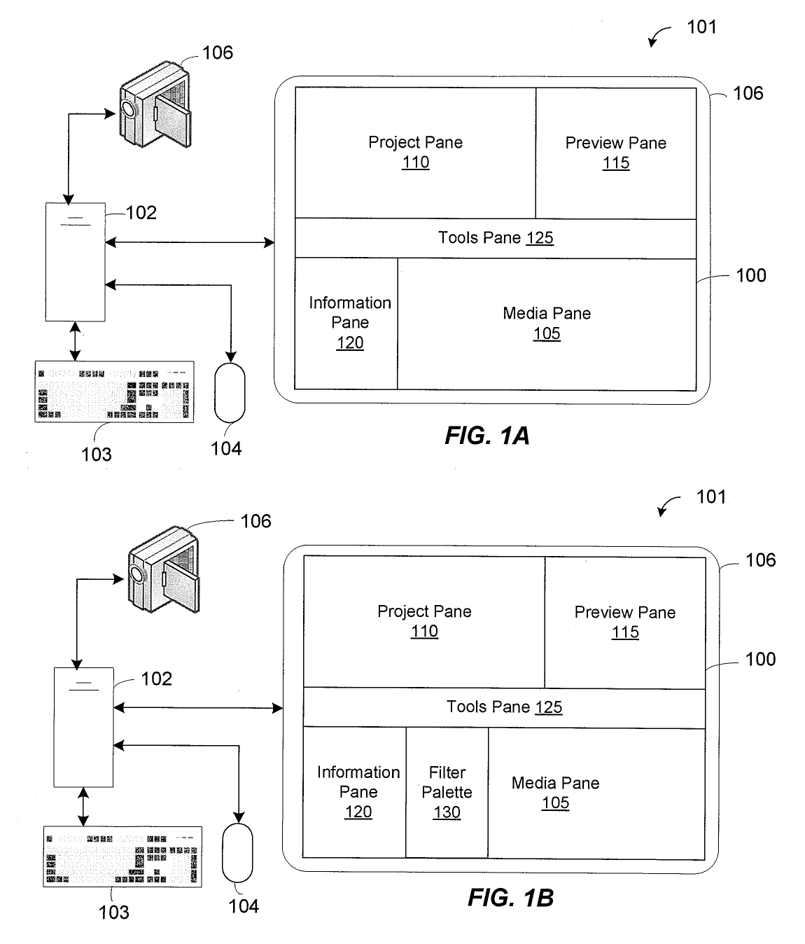

FIG. 1A depicts an example of a system 101 for performing video editing. The system 101 includes a recording instrument 106, a CPU 102, a display device 107, an input device such as a keyboard 103 and/or a pointer 104. The display device 107 is used to display a user interface 100. The user interface 100 includes a media pane 105, a project pane 110, a preview pane 115, an information pane 120, and a tools pane 125.

FIG. 1B also depicts a schematic of an example of a system 101 for performing video editing where the user interface 100 also includes a filter palette 130. The filter palette 130 is used to filter video clips based on keywords associated with the video clips. The keywords can be associated with complete video clips or segments of video clips. The user can input the keywords. In another example, the keywords are input automatically by the system.

The filter palette allows a user to select an INCLUDE or an EXCLUDE selector for keywords associated with media items such as video clips or photographs. The keywords can be associated with a complete video clip and/or with a segment of the video clip. When the users selects activates the filter, the system 101 filters the media items based on the selected INCLUDE and EXCLUDE selectors. The automated system displays the media items having the keywords for which INCLUDE was selected while not displaying media items having keywords for which the EXCLUDE was selected. The automated system also allows the user to select a Boolean AND operation or a Boolean OR operation. If the Boolean AND operation is selected, the only media items that are displayed are those that have all the associated keywords for which INCLUDE was selected. If the Boolean OR operation is selected, the system displays the media items having any of the associated keywords for which INCLUDE was selected.

In one example, video clips containing raw footage recorded using a recording instrument 106 are uploaded and stored on the CPU in a video library. Video clips from the video library are uploaded into the user interface 100 and displayed in the media pane 105.

When the user interface is opened, the system can display the available video libraries in the information pane 120. In other implementations, when the user interface is opened, the system can automatically search the storage device for video clips and display all available video clips in the media pane 105. In other implementations, the system can retrieve stored video clips based on user input. User input can be provide via an input device such as a keyboard 103, or a pointer device 104. All video clips selected by the user can be uploaded into the user interface 100 and displayed in the media pane 105 regardless of the type of the video clip or the recording instrument. The video clips can be recorded using any recording instrument 106, including digital camcorders, digital cameras, and cellular telephones. The video clips can then be uploaded the CPU 102. Video clips can also be obtained directly from other data storage devices, such as USB storage devices, memory cards, CDs, DVDs, and the like. In another implementation, video clips can be obtained from another storage device or recording instrument 106 via a network. The video clips can be stored in any format including quicktime, mpeg-1, mpeg-2, AVI, and real video. In addition, the time period of each video clip can be displayed on or adjacent to a corresponding video clip.

The project pane 110 includes one or more segments from one or more of the video clips displayed in the media pane 105 that can be selected by the user for editing. When segments are selected and transferred from the media pane 105 to the project pane 110, a project is automatically created. In some implementations, a pane displaying projects can be displayed adjacent to the project pane 110. Subsequent to editing, the contents of a project pane 110 can be saved as a finished project. A finished project can be saved in any format including quicktime, AVI, mpeg-1, mpeg-2, and real, regardless of the format of the video from which each segment in the project was obtained. A saved project can be re-opened for further editing. In addition, the project pane 105 can also include representations to indicate additional content including audio tracks, voice-overs, titles, transitions between frames, and the like.

Video in a video clip is stored as a sequence of frames. The preview pane 115 displays frames, wherein a frame is one of the plurality of photographic images in a motion picture. A frame displayed in the preview pane 115 corresponds to a time instant in the video clip. The preview pane 115 can display frames corresponding to content displayed in the media pane 105 and content displayed in the project pane 110. In addition, the preview pane 115 plays back video content displayed in the media pane 105 and in the project pane 110, based on user input. Based on system capabilities, the content played back in the preview pane 115 can include audio content recorded along with the video content or added to the raw footage. A user can preview the effect of editing the video content in the preview pane 115.

In some implementations, the information pane 120 can display data including metadata related to the one or more video clips in the media pane 105. For example, the information pane 120 can display the name of the video clip, the location where the video clip is stored, the time when the video clip was recorded, the duration of the clip, the size of the clip (e.g., in megabytes), and the like. In some implementations, the information pane 120 can display the metadata related to all the video clips in the media pane 105. In other implementations, the information pane 120 can display the metadata related to the video clip that a user is editing. The information pane 120 can continuously be updated as video clips are added, deleted, or edited. In some implementations, the user can hide the information pane 120 from display. In such implementations, the horizontal dimension of the media pane 105 can be automatically adjusted to occupy the void created by hiding the information pane 120. The user interface 100 can include a tools pane 125. The tools pane 125 can include user interface controls that a user can activate to perform editing operations including assigning keywords.

In some implementations, the media pane 105 and the information pane 120 can be arranged adjacent to each other in the same row. A tools pane 125 can be positioned above the media pane 105 and the information pane 120 such that the horizontal dimension of the tools pane 125 equals the sum of the horizontal dimensions of the media pane 105 and the information pane 120. The project pane 110 and the preview pane 115 can be positioned above the tools pane 125 such that the sum of the horizontal dimensions of the project pane 110 and the preview pane 115 equals the horizontal dimension of the tools pane 125. Alternatively, the panes can be positioned in a different arrangement. A user can alter the dimensions of each pane by altering the dimensions of the user interface 100. Alternatively, the user can individually alter the dimensions of each pane. For example, a user can increase the vertical dimension of the tools pane 125. This may cause the dimensions of the project pane 110 and the preview pane 115 to be altered such that the dimensions of the user interface 100 remain unaltered. Alternatively, an alteration to the dimensions of one of the panes can cause the dimensions of all the panes and the user interface 100 to be uniformly altered. In some implementations, a user can hide panes from being displayed. In such implementations, the dimensions of one or more of the displayed panes may automatically be altered to occupy the void created by the hidden pane, such that the display of the user interface 100 is substantially rectangular in shape. A pane can be included in the user interface 100 based on user input. The dimensions of the displayed panes can automatically be adjusted to accommodate the added pane such that the dimensions of the user interface 100 remain unaltered and the display of the user interface 100 remains substantially rectangular in shape.

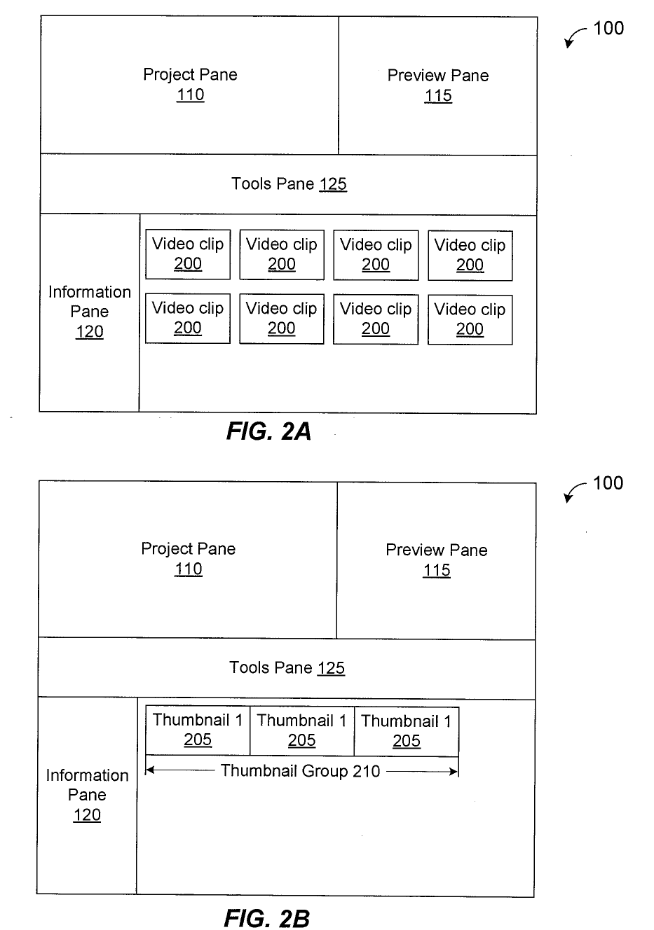

FIG. 2A depicts an example of a schematic of a user interface 100 displaying each video clip 200 as a thumbnail. A video clip 200 includes the content recorded by a recording instrument from the instant the recording feature is turned on to the instant the recording feature is turned off. In addition, a video clip 200 can include digitized clips, e.g., video tape converted into digital format, and the like. When the video clips 200 in a video library are uploaded into the user interface 100, each video clip 200 is displayed as one or more rows of rectangular thumbnails. The time line of a video clip 200 runs from left to right and top to bottom. In some implementations, each video clip 200 can be represented by a single rectangular thumbnail with a system defined distance separating each thumbnail to distinguish between video clips. Thumbnails are displayed in a first row until the sum of the horizontal dimensions of the thumbnails exceed the horizontal dimension of the media pane 105 displayed. Subsequent thumbnails are wrapped to the next row in the media pane 105. A gutter, which is a system designated space, separates two rows of thumbnails.

FIG. 2B depicts an example of a schematic of a user interface 100 displaying a video clip 200 as a thumbnail group 210. The thumbnail group 210 collectively representing the video clip is displayed as a continuous sequence of one or more rectangular thumbnails 205. The vertical and horizontal dimensions of each thumbnail 205 are designated by the system. Each video clip 200 is collectively represented by a thumbnail group 210. Each thumbnail group 210 can include one or more thumbnails 205. Thumbnails 205 related to the same thumbnail group 210 are displayed as a continuous sequence. Thumbnail groups 210 corresponding to separate video clips are displayed such that the last thumbnail 205 of a thumbnail group 210 is separated from the first thumbnail 205 of the subsequent thumbnail group 210. The order of display of the thumbnails in the thumbnail group corresponds to the order in which the corresponding video clips were stored on the storage device. Progression of time corresponds to positioning of the thumbnails going from left to right in the horizontal direction and top to bottom in the vertical direction. A video clip 200 can be included to or removed from display in the user interface 100 based on user input. When a thumbnail group 210 corresponding to a video clip 200 is hidden, then the remaining thumbnail groups 210 are re-arranged to fill the gaps corresponding to the hidden thumbnail group 210. In this manner, the thumbnail groups 210 are displayed in a manner analogous to words in a word processing application user interface.

Each thumbnail 205 is assigned a segment of the time period of video content in the video clip 200. The duration of a video clip 200 is divided by the time period assigned to each thumbnail 205. In this manner, the number of thumbnails 205 in a thumbnail group 210 required to display the video clip 200 is determined. The duration of a video clip 200 may be exactly divisible by the time period assigned to each thumbnail 205 with no remaining time. In such cases, when the duration of the video clip 200 is divided by the time assigned to each thumbnail 205, the number of thumbnails 205 in a thumbnail group 210 required to display the video clip 200 equals the quotient of division (Q) with no time remaining. The video clip 200 is displayed across Q thumbnails 205 in the thumbnail group 210. Alternatively, there may be time remaining after dividing the total time period of the video clip 200 by the time period assigned to each thumbnail 205. In such cases, the number of thumbnails 205 in the thumbnail group 210 required to display the video clip 200 equals the quotient of the division (Q) plus one. The video clip 200 is displayed across (Q+1) thumbnails 205 in the thumbnail group 210. Also, in such cases, the time period corresponding to the last thumbnail 205 in the thumbnail group 210 is less than that corresponding to the other thumbnails 205 in the thumbnail group 210. Nevertheless, the dimensions of all the thumbnails 205 in the thumbnail group 210 related to a video clip 400 are uniform. In some implementations, the segment corresponding to the last thumbnail 205 is automatically distributed across the entire horizontal dimension of the last thumbnail 205. In other implementations, based on the time period corresponding to the last thumbnail 205, the video clip 200 is distributed across all the thumbnails 205 in the thumbnail group 210 such that each thumbnail 205 in the group 210 represents equal duration of content. In other implementations, the segment of the last thumbnail 205 of the video clip 200 containing no video content is filled with a color, for example, grey, when the cursor on the display device is placed on the thumbnail. In this manner, a user can readily discern that the filled segment of the last thumbnail 205 of a thumbnail group 210 is void of any video content. The segment of the thumbnail 205 void of content is not used during editing. The aesthetics of the user interface 100 are improved by keeping the dimensions of all the thumbnails 205 in the thumbnail group 210 uniform and avoiding the display of fractionated thumbnails 205 to represent content of shorter time periods.

A user can alter the time period assigned to the thumbnails 205 in the user interface 100. The thumbnails 205 in the project pane 110 can be assigned a different time period than the thumbnails 205 in the media pane 105. In some implementations, a first interactive scale and a second interactive scale are displayed adjacent to the media pane 105 and the project pane 110, respectively. The scales are operatively coupled to the respective panes such that the time assigned to thumbnails in the media pane 105 and that assigned to the thumbnails in the project pane 110 can be independently altered by sliding the first scale and the second scale, respectively. In some implementations, the time period corresponding to each thumbnail 205 is assigned by the system. In other implementations, the time period corresponding to each thumbnail 205 is specified by the user. In other implementations, when a video clip 200 is first loaded into the media pane 105, each thumbnail 205 is assigned a time period that is equal to a system default value. A user can alter this value to a user-defined value within limits specified by the system.

The vertical and horizontal dimensions of the thumbnails 205 are uniform and are designated by the system. The dimensions of the media pane 105 and the project pane 110 may be insufficient to display all the thumbnails 205 related to one or more thumbnail groups 210 in the same row. In some implementations, an interactive scale is displayed adjacent to the media pane 105 and the project pane 110. The scale is operatively coupled to the dimensions of the thumbnails in the media pane 105 and the project pane 110. A user can change the position of the scale to increase or decrease the size of the thumbnails 205 in the media pane 105 and the project pane 110. In this manner, the size of the thumbnails 205 displayed in the media pane 105 and the project pane 110 can be simultaneously altered. In other implementations, the size of the media pane 105 is automatically increased to accommodate all thumbnails 205 by adding rows. Nevertheless, the dimensions of the media pane 105 displayed remain unaltered. A vertical scroll bar is incorporated into the media pane 105 so that the user may scroll vertically to access video clips 200 that are not immediately viewed. In other implementations, the user can pan the media pane 105 using the pointing device or the keyboard or both. The size of display of the thumbnails 205 can also be altered by a combination of resizing thumbnails using an interactive scale and increasing the size of the media pane 105.

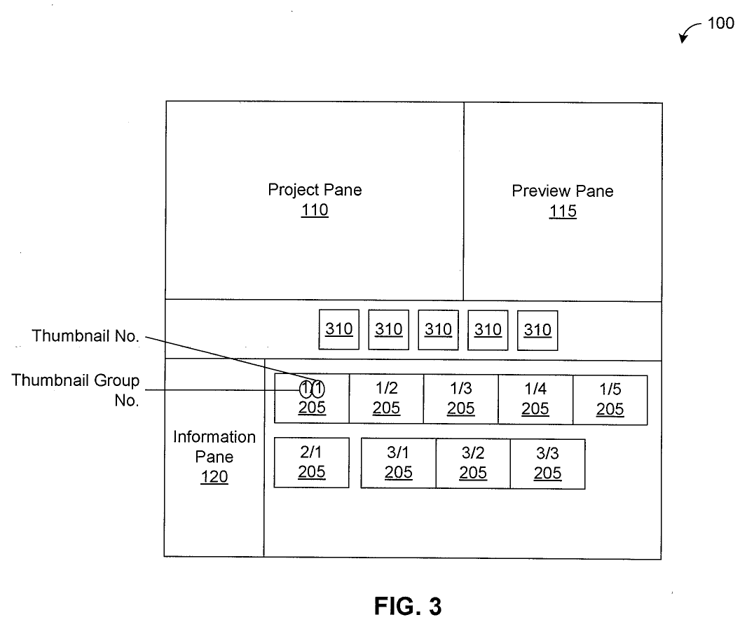

FIG. 3 depicts an example of a schematic of a user interface 100 displaying a plurality of video clips 200 as corresponding thumbnail groups 210. Each thumbnail group 210 includes one or more thumbnails 205. In some implementations, all video clips 200 of a video library can be automatically uploaded into the user interface 100 and displayed in the media pane 105 as rows of thumbnail groups 210. In other implementations, one or more video clips 200 of a video library can be selectively uploaded into the user interface 100, based on user input, and displayed in the media pane 105. The default dimensions of the user interface 100 are designated by the system. Based on the time period assigned to a thumbnail 205 and based on the duration of a video clip 200, each video clip 200 is distributed across one or more thumbnails 205 in a thumbnail group 210. In the example shown, in the default view of the user interface 100, the thumbnail groups 1, 2, and 3 correspond to video clips 1, 2, and 3 which are displayed across 5, 1, and 3 thumbnails, respectively. If the total horizontal dimension of the thumbnails 205 in a row exceeds that of the media pane 105, a new row is added, and subsequent thumbnails 205 are wrapped within the media pane 105 and displayed in the following row. The size of the thumbnails in the media pane 105 and the project pane 110 can be altered proportionally based on user input.

The number of thumbnails 205 in a thumbnail group 210 to display the video clips 200 is automatically altered based on the time period assigned to each thumbnail 205. When a video clip 200 is displayed across one or more thumbnails 205 in a thumbnail group 210, the time periods corresponding to each thumbnails 205 are equal to one another, except for the last thumbnail 205 in each thumbnail group 210. The time period corresponding to the last thumbnail 205 in a thumbnail group 210 is either less than or equal to, but not greater than, the time period corresponding to other thumbnails 205 in the same thumbnail group 210. Alternatively, the duration of a video clip 200 can be distributed equally across all the thumbnails in a thumbnail group. In such cases, the time period associated with a thumbnail in a first thumbnail group may be different from the time period associated with a thumbnail in a second thumbnail group. Each video clip 200 can be displayed as a single thumbnail 205 in response to user input. In such implementations, the dimensions of the thumbnails 205 corresponding to the video clips 200 are equal to one another. The duration of the video clips 200 represented by a thumbnail 205 need not be equal to one another.

When a cursor on the display device is placed over a thumbnail 205 in the user interface 100, a playhead is displayed on the display device at the position of the cursor. In some implementations, the playhead is a vertical line of height equal to the vertical dimension of the thumbnail 205. When the cursor is placed at a position away from a thumbnail 205, the playhead disappears. A user may alter the position of the cursor on the display device by operating the pointing device or the key board or both. When the playhead is positioned at a position on a thumbnail 205, a frame in the video corresponding to a time instant determined by the position of the playhead on the thumbnail is displayed in the preview pane 115. In addition, the frame corresponding to the position of the cursor is also displayed in the bounded region of the thumbnail on which the cursor is placed. In this manner, frames related to video content displayed across one or more thumbnails in the media pane 105 and the project pane 110 can be previewed in the preview pane 115.

When the playhead is positioned on a thumbnail 205, a frame in the video clip 200 corresponding to the position of the playhead is displayed on the thumbnail 205. As the playhead is moved across the thumbnail 205, the display on the thumbnail 205 is continuously updated with the frame corresponding to the new position of the playhead. Further, the frame that is displayed on the thumbnail 205 is simultaneously displayed on the preview pane 115. As the frames displayed on the thumbnail 205 are updated as the playhead is moved, the frames displayed in the preview pane 115 are also updated.

In addition, the tools pane 125 includes user interface controls 310. In some implementations, the user interface controls 310 are displayed as rectangular shaped buttons arranged adjacent to each other and are horizontally aligned. A user interface control 310 can be configured to perform editing functions including assigning keywords to content. A user can activate a user interface control 310 using the cursor controlled by the pointing device, the keyboard, or both. For example, the cursor may be operated using a pointing device such as a mouse. A user can activate a user interface control 310 by placing the cursor on the control and clicking the mouse. In response, the user interface control 310 may be configured to perform an editing operation which may require user input. Such user input may cause a new interface to be displayed on the display device. The new interface may be positioned over the user interface 100.

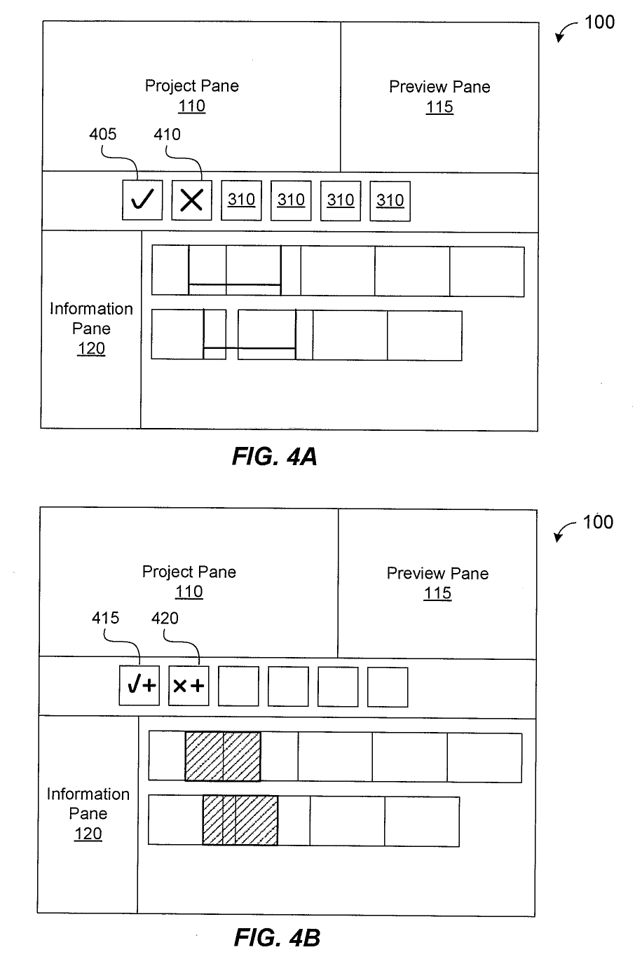

FIG. 4A depicts an example of a schematic of a user interface 100 displaying user interface controls 310. In this example, a user interface control button can be activated and segments of video clips can be selected to assign keywords. In some implementations, a user can upload video clips for display in the media pane 105. The video clips 200 are displayed as thumbnail groups 210 comprising one or more thumbnails 205. Using the user interface controls 310, a user can group segments of the video clip by assigning keywords to the video clip. The tools pane 125 can include two user interface control buttons, e.g., a “check” button 405 and a “cross” button 410. A user can use the check button 405 or the cross button 410 to present for display or hide from display, respectively, segments of one or more video clips. In some implementations, a user can activate the check button 405 using the cursor. Subsequent to activating the check button 405, the cursor can be positioned on the thumbnail group where the playhead is displayed. A segment of the video clip can be selected by a pointing device configured to operate the playhead. For example, when a mouse is used to operate the playhead, the mouse can be clicked at the first position on the thumbnail group representing the video clip, the mouse can be dragged to a second position representing the same or different video clip, and the mouse can be released. The second position can be located in the same row as the first position or in a different row. In the same row, the first position can be located to the right or to the left of the second position. In this manner, the segment of the video clip between the first and the second position can be selected. The first and second position can be related to the same thumbnail group. Alternatively, the first and second position can be related to different thumbnail groups. The first and second position may be on the same row of thumbnails or on different rows of thumbnails. Alternatively, the playhead can be operated using a different device, e.g., a key board. The playhead can also be operated using a combination of the key board and the mouse.

In some implementations, the user can select more than one segment from the same or different video clips after activating the check button 405. The check button 405 can be deactivated after selecting segments of video clips. For example, when the cursor is operated by a mouse, a user can activate the check button 405, select a first position, click and drag the mouse to the second position, release the mouse at the second position, deactivate the check button 405. Between activation and deactivation, a user can select one or more segments. In other implementations, the check button 405 can be deactivated once the second position is chosen. For example, a user can activate the check button 405, select a segment of the video clip by clicking and dragging the mouse, and release the mouse at the second position. When the second position is selected, the check button 405 can be automatically deactivated. This can allow a user to resume editing operations without deactivating the check button 405. In some implementations, a user can be presented with modes, wherein a first mode can allow a user to manually activate and deactivate the check button 405 so that a user can select multiple segments of video clips for editing, while a second mode can deactivate a check button 405 after a first selection. A user can choose a mode depending upon the user's editing requirements.

A selected segment of a video clip can be indicated by a line displayed over the segment between the initial and final positions. Each line can be displayed in a different color such that each color represents a keyword. Segments of video clips that are assigned the same keywords can be indicated by lines having the same color. As the user scrolls the playhead over the thumbnail groups 210 between the first and the second position, an indicator, e.g., a balloon containing text, can be displayed adjacent to the playhead to indicate the keywords assigned to the scanned segments.

The segments of the video clips that are selected using the check button 405 can be filtered for display. In some implementations, the user can hide from display all the segments that have not been selected using the check button 405. In this manner, only the segments selected using the check button 405 can be displayed in the media pane 105. In other implementations, the segments selected using the check button 405 can automatically be transferred to the project pane 110. The remaining segments can be displayed in the media pane 105. In other implementations, the segments selected using the check button 405 can be displayed in the project pane 110. The media pane 105 can display all the video clips.

The operations performed to choose segments of video clips for display can also be performed to hide segments of video clips from display using the cross button 410. For example, a user can activate the cross button 410, select one or more segments of one or more thumbnail groups by selecting a first position, clicking and dragging a mouse to a second position, and releasing the mouse. A line displayed across the selected segment can display an indicator, e.g., a balloon containing text, describing that the selected segment has been chosen to be hidden from display. In this manner, a user can categorize video clips into content for presentation and content for hiding using tools displayed in the tools pane 125. In some implementations, the check button 405 and the cross button 410 can be displayed using a “thumbs up” sign and a “thumbs down” sign to signify content for display and content for hiding, respectively. In some implementations, the check button 405 can be assigned to content that the user determines to be good content, while the cross button 410 can be assigned to content that the user determines to be bad content.

FIG. 4B depicts an example of a schematic of a user interface 100 displaying user interface control buttons 300. In this example, a user can select segments of video clips and subsequently activate user interface control buttons to assign keywords. In some implementations, a user can select a segment of a video clip. A user can position the playhead at a first position on a thumbnail, select the first position by clicking a pointing device configured to operate the playhead, drag the pointing device to a second position, and release the pointing device. A rectangular region of vertical dimension equal to the vertical dimension of a thumbnail and a horizontal dimension equal to the distance between the first and the second chosen positions can be displayed over the selected segment. In some implementations, the rectangular region can be translucent to permit viewing of the selected segment that is displayed beneath the region.

In some implementations, a user can select segments of video clips before activating the user interface control buttons to assign keywords. When the user selects a segment of a video clip before activating the user interface control, the display of the check button 405 and the cross button 410 can be replaced with the new check button 415 and the new cross button 420. The new check button 415 and the new cross button 420 can include a “+” sign within the bounded region of the user interface control button to indicate that segments of video clips are being or have been selected prior to activating the control button. A user can select one or more segments of video clips using the pointing device, the key board, or both. Subsequent to selecting segments of video clips, the user can activate a user interface control 310. The editing operations which the selected user interface control 310 is configured to perform are performed on the selected segments. In one example, a user can select one or more segments of video clips and activate the new check button 415. In this manner, the selected segments can be chosen to be displayed in the project pane 110. In another example, a user can select one or more segments of video clips and activate the new cross button 420. In this manner, the selected segments can be hidden from display in the media pane 105.

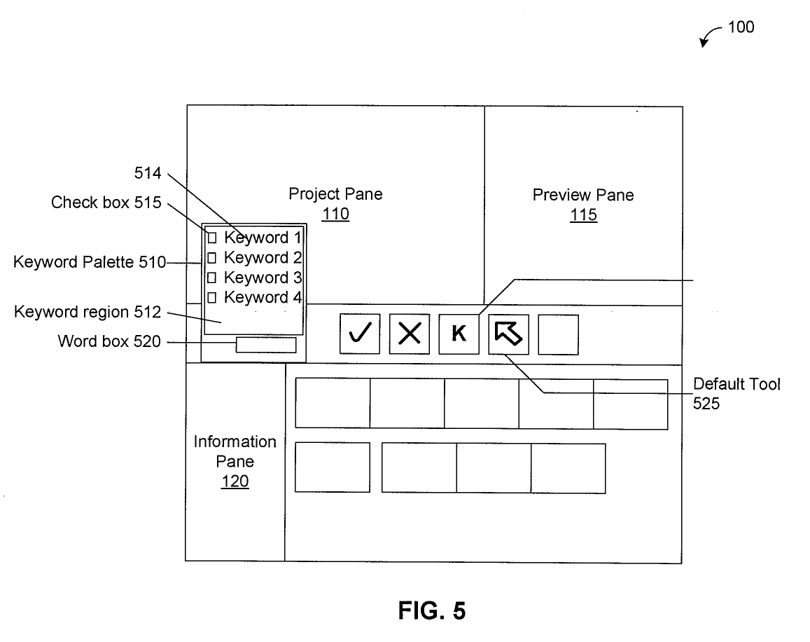

FIG. 5 depicts an example of a user interface 100 including a keyword tool 505. In some implementations, the tools pane 125 can include a keyword tool 505. The keyword tool 505 can be configured to allow a user to assign keywords to all or segments of the video clip. When a user activates the keyword tool 505, a keyword palette 510 can be displayed on the user interface 100. The dimensions of the keyword palette 510 can be altered based on user input. The keyword palette 510 can include a keyword region 512. The keyword region 512 can include a list of keywords 514 available to be assigned to the video clips. The keyword region 512 can also include check boxes 515 related to the keywords 512. A check box 515 can be positioned adjacent to a keyword 514. In some implementations, a user can activate a keyword 514 by selecting the check box 515 positioned adjacent to the keyword using the cursor.

The keyword palette 510 can include a word box 520. The word box 520 can be used to add keywords to the keyword palette 510. In some implementations, the word box 520 can be displayed adjacent to the bottom horizontal edge of the keyword palette 510. Alternatively, the word box 520 can be displayed adjacent to the top horizontal edge of the keyword palette 510. The sum of the vertical dimension of the keyword region 512 and the vertical dimension of the word box 520 can be less than or equal to the vertical dimension of the keyword palette 510. A user can enter keywords in the word box 520 by positioning the cursor anywhere in the region of the word box 520 and entering text using a suitable device, e.g., a key board. In a default implementation, the keyword region 512 can contain no keywords. Subsequently, the keyword region 512 can include “Good” and “Bad” as keywords assigned to content selected using the check button 405 and the cross button 410, respectively. A user can perform coarse editing operations to the video clips by either activating the check button 405 and the cross button 410 in the tools pane 125 or checking the check boxes 515 adjacent to keywords “Good” and “Bad” in the keyword palette 510. The keyword region 512 can then be populated with keywords added by a user via the word box 520.

The keyword region 512 can have a vertical and a horizontal dimension. A keyword 514 and the related check box 515 can be arranged in a row within the keyword region 512. The first row containing a keyword 514 and a check box 515 can be positioned substantially adjacent to the top left corner of the keyword region 512. A second row containing a keyword 514 and the related check box 515 can be positioned in a second, vertically displaced row within the keyword region 525. A space can be assigned between the first row and the second row. The check boxes 515 of each row can be substantially vertically aligned with each other. In this manner, rows containing keywords 514 and check boxes 515 can be added to the keyword palette 510 and the keywords 514 and the check boxes 515 can be displayed in the keyword region 512.

In some implementations, a decrease in the dimensions of the keyword palette 510 can cause a decrease in the horizontal dimension of the keyword region 525. If the horizontal dimension of the row containing the keyword 514 and the check box 515 is greater than the dimension of the keyword region 514, a horizontal scroll bar (not shown) can be incorporated in the keyword region 512 to allow scrolling to view the keywords. In other implementations, if the horizontal dimension of the keyword region 512 is less than the horizontal dimension of the row containing the keyword 514 and the check box 515, when the user positions the cursor over a row in the keyword region 512, a balloon displaying the entire content of the row may be displayed adjacent to each row. When the user moves the cursor away from the keyword region 512, the balloon may be hidden from display. In this manner, the user can view the contents of each row in the keyword region 512 when the entire content is not displayed.

When a user enters a new keyword 514 in a word box 520, the new keyword 514 can be included to the list of keywords displayed in the keyword region 512. In addition, a check box 515 related to the new keyword 514 can also be displayed adjacent to the new keyword 514. Further, the check box 515 can be activated when the keyword 514 is added to the list. In some implementations, the new keyword 514 can be included as the last keyword in the list of keywords. In other implementations, the new keyword can be included as the first keyword in the list of keywords. If the sum of vertical dimensions of each row of keywords exceeds the vertical dimension of the keyword region 512, a vertical scroll bar can be incorporated in the keyword region 512 to allow scrolling to view the keywords 514 and check boxes 515 that are hidden from display. In this manner, a user can access all the keywords 514 in the keyword palette 510. In addition, when a new keyword 514 is added to the keyword palette 510, the keyword region 512 is rearranged so that the new keyword 514 and the related check box 515 are displayed in the user interface 100.

In some implementations, a user can open the keyword palette 510 by activating the keyword tool 505. The user can choose a keyword 514 displayed in the keyword palette 510 by checking the check box 515 related to the keyword 514. Subsequently, the user can position the cursor at a first position on a thumbnail related to a video clip and select a segment of the video clip starting from the first position to a second position. The chosen keyword 514 can be assigned to the selected segment of the video clip. Alternatively, the user can first select a segment of a video clip. Subsequently, the user can open the keyword palette 510 by activating the keyword tool 505. The user can choose a keyword 514 in the keyword palette 510 by selecting the check box 515 related to the keyword 514. The selected segment can be assigned the chosen keyword 514. In this manner, the user can assign keywords to all or segments of one or more video clips.

The tools pane 125 can include user-configured tools. A user can add a tool to the tools pane 125 for display and configure the tool to perform user-specific editing operations. The tools pane 125 can include a default tool 525. The default tool 525 can be configured to deactivate all other tools in the tools pane 125. For example, a user can perform editing operations including assigning keywords to all or segments of the video clips. Subsequently, the user can activate the default tool 525 to deactivate the keyword assigning operation.

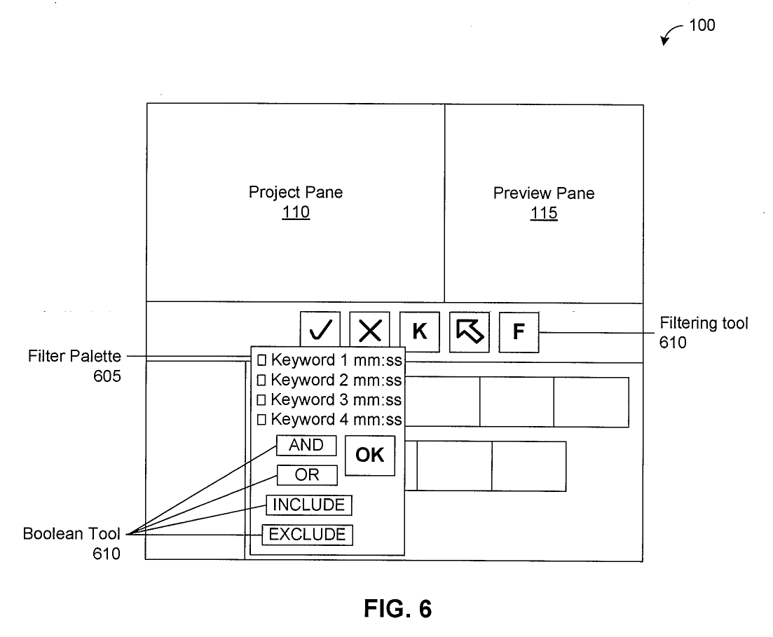

FIG. 6 depicts an example of a filter palette 605 that a user can use to select content for display based on assigned keywords. In some implementations, a tool on the tools pane 125 can be configured such that a filter palette 605 can be displayed on the user interface 100 when a user activates the filtering tool 610. In some implementations, the filtering tool 610 can be displayed in the tools pane 125. In other implementations, the filtering tool can be displayed anywhere in the user interface 100. The filter palette 605 can include all the keywords assigned to the segments of the video clips. The keywords can include default keywords, e.g., “Good,” and “Bad,” as well as user-assigned keywords. In addition, the filter palette can also display the time duration for which the keyword is assigned, e.g., in minutes (mm) and seconds (ss).

The filter palette 605 can also include Boolean tools 610 titled, for example, “And,” “Or,” “Include,” and “Exclude.” The Boolean tools 610 can be configured such that the content to which keywords have been assigned can be filtered based on the Boolean tool 610 that a user specifies. A segment of content can be assigned more than one keyword. Some segments of the video clip may not be assigned keywords. A user can use the filter palette 605 to display content based on keywords.

In some implementations, a user can activate the filter palette 605. The filter palette 605 can display all the keywords assigned to the video clips. The user can select a keyword by positioning the cursor on the check box adjacent to the keyword. A user can accept this selection by clicking on the “OK” button. All segments of the video content assigned the chosen keyword can be displayed while remaining segments of content assigned no or different keywords can be hidden from display in the media pane 105. In other implementations, all the segments assigned the chosen keyword can be displayed in the project pane 110.

In some implementations, a user can select more than one keyword by choosing more than one check box in the filter palette 605. After selecting more than one keyword, a user can filter the video clips based on Boolean logic. For example, a segment of the video clips can be assigned “Keyword 1” and “Keyword 2.” In the filter palette 605, the user can select the check boxes adjacent to “Keyword 1” and “Keyword 2,” and select the “And” Boolean tool 610. When the user selects “OK,” the segments of video clips that have been assigned both “Keyword 1” and “Keyword 2” are displayed in the media pane 105 while the remainder of the video clips are hidden from display. Alternatively, the segments of video clips that have been assigned both keywords can be displayed in the project pane 110 for further editing. In this manner, a user can display segments of video clips that have been assigned multiple keywords.

In another example, a first segment of the video clips can be assigned “Keyword 1” and a second segment of the video clips can be assigned “Keyword 2.” In the filter palette 605, the user can select the check boxes adjacent to “Keyword 1” and “Keyword 2,” and select the “Or” Boolean tool 610. When the user selects “OK,” the segments of video clips that have been assigned either “Keyword 1” or “Keyword 2” can be displayed in the media pane 105. Alternatively, the segments of video clips that have been assigned either of the keywords can be displayed in the project pane 110 for further editing.

In some implementations, some segments of the video clips may not be assigned a keyword. A segment of the video clips may be assigned “Keyword 1.” In the filter palette 605, the user can select the check box adjacent to “Keyword 1,” and select the “Include” Boolean tool 610. When the user selects “OK,” the segments of the video clips that are not assigned a keyword including the segment of the video clips assigned “Keyword 1” can be displayed in the media pane 105. Alternatively, the segments of video clips that have not been assigned a keyword including the segment of the video clips assigned “Keyword 1” can be displayed in the project pane 110 for further editing.

In some implementations, a segment of the video clips may be assigned “Keyword 1.” In the filter palette 605, the user can select the check box adjacent to “Keyword 1,” and select the “Exclude” Boolean tool 610. All segments of video clips excluding the segment of video clips assigned “Keyword 1” can be displayed in the media pane 105. Alternatively, all segments of video clips excluding the segment assigned “Keyword 1” can be displayed in the project pane 110 for further editing. In this manner, the user can assign keywords to the video clips displayed in the media pane 105 and, subsequently, either filter the content displayed in the media pane 105 or transfer the keyword assigned content to the project pane 110 for further editing.

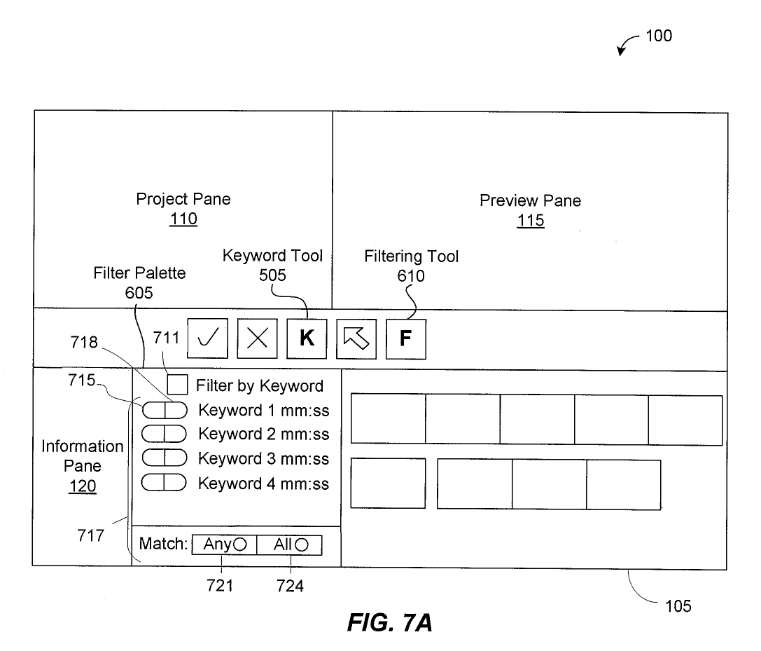

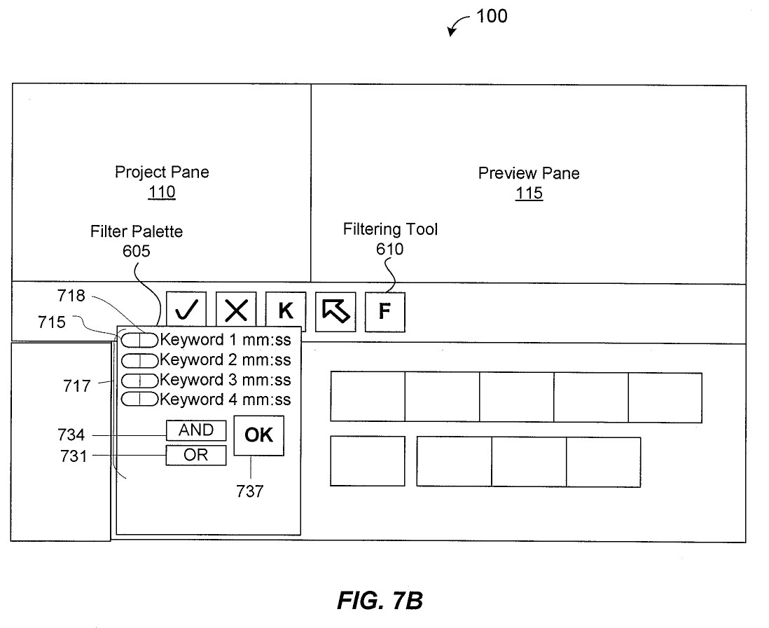

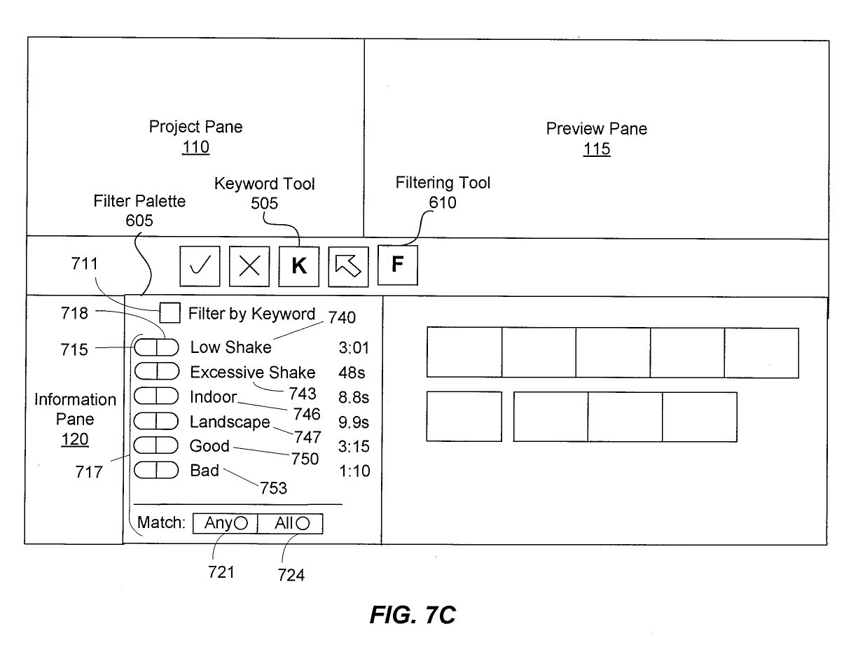

FIGS. 7A-7C depict examples of a filter palette 605 that a user can use to select content for display based on assigned keywords. In FIG. 7A the filter palette 605 is between the information pane 120 and the media pane 105. The filter palette 605 includes check box 711 for activating the filter tool. The filter palette also includes one or more Boolean tools 717. Each Boolean tool 717 that corresponds to an associated keyword has an inclusion selector and an exclusion selector depicted using an INCLUDE button 715 and an EXCLUDE Button 718 for each keyword. For each keyword, a user can select the INCLUDE button 715, the EXCLUDE button 718, or make no selection at all. When a user selects the INCLUDE button 715, the INCLUDE button turns green, indicating its selection. If the user clicks the INCLUDE button 715 again, the INCLUDE button is unselected and returns to its original color. When the EXCLUDE button 718 is selected, the EXCLUDE button 718 turns red, indicating its selection. If the user clicks the EXCLUDE button 718 again, the EXCLUDE button 718 is unselected and returns to its original color. If the INCLUDE button 715 is selected, and the user then selects the EXCLUDE button, the INCLUDE button 715 becomes unselected and returns to its original color while the EXCLUDE button turns red. If the EXCLUDE button 718 is selected, and the user then selects the INCLUDE button, the EXCLUDE button becomes unselected and returns to its original color while the INCLUDE button turns green. In other words, for each keyword the filter can be set to INCLUDE, EXCLUDE, or no selection. A user can select an INCLUDE button or an EXCLUDE button for more than one keyword. A user can make any combination of selections of the INCLUDE and EXCLUDE buttons for the various keywords, depending on the desired filter.

Also, Boolean tools 717 include a Boolean OR operation selector such as an ANY button 721 and a Boolean AND operation selector such as an ALL button 724. The user can select either the ANY button 721 or the ALL button 724. In one example, the ANY button 721 and the ALL button 724 can be radio buttons that require that either the ANY button 721 be selected or the ALL button 724 be selected. When the user opens the filter palette, one of these buttons, such as the ANY button 721, is selected by default. A user can change the selection by clicking on the other button. Therefore, either the ANY button 721 or the ALL button 724 is always selected. When the “Filter by Keyword” check box 711 is selected the media items in the media pane 105 are filtered according the selected Boolean tools.

For example, assume user selects the INCLUDE button for keyword 1, the INCLUDE button for keyword 2, and the ANY button. If the “Filter by Keyword” box is checked, the media items that have been assigned either or both of “Keyword 1” and “Keyword 2” are displayed, for example, in the media pane 105 while the remainder of the media items are hidden from the display. In other words, the ANY button, when selected, acts as a Boolean “OR” operator that causes any and all media items associated with any of the selected INCLUDE keywords to be displayed. Furthermore, if the EXCLUDE button for “Keyword 3” also is selected, for example, then the media items that have been assigned either “Keyword 1” or “Keyword 2” are displayed while the remaining media items and media items that have been assigned “Keyword 3” are hidden. In other words, if a media item has been assigned “Keyword 1” and “Keyword 3”, for example, then that media item is hidden.

In another example, assume the user selects the INCLUDE button for “Keyword 1” and “Keyword 2,” and also selects the ALL button. If the “Filter by Keyword” box is checked, only those media items that have been assigned both “Keyword 1” and “Keyword 2” are displayed, for example, in the media pane 105 while the remainder of the media items are hidden from the display. In other words, the ALL button, when selected, acts as a Boolean “AND” operator that causes only those media items associated with all of the selected INCLUDE keywords to be displayed. Furthermore, if the EXCLUDE button for “Keyword 3” also is selected, for example, then the media items that have been assigned “Keyword 1” and “Keyword 2” are displayed while the remaining media items and any media items that have been assigned “Keyword 3” are hidden. In other words, a media item has been assigned “Keyword 1,” Keyword 2,” and “Keyword 3”, for example, is hidden. In this manner, a user can select which media items to display and which media items to specifically exclude from the display. These examples have been given by way of illustration. A user can make any combination of selections of the Boolean tools.

A button includes any type of selector, such as a check box, cross box, radio button, drop down list, toggle button, etc. The “Filter by Keyword” box 711 allows for real-time filtering of the media items. If the filter by keyword is selected then the media items are filtered as the user selects or unselects the Boolean tools. In another example, as seen in FIG. 7B, the filter palette 605 includes an “OK” button 737. The user first selects the desired Boolean tools and then clicks the “OK” button 737. The filtering occurs only upon clicking the “OK” button 737. Also, the filter palette 605 can be included as part of the user interface as shown in FIG. 7A or over the user interface as seen in FIG. 7B. Also, in FIG. 7B, the ANY button 721 and the ALL button 724 have been replaced by Boolean operation selectors OR button 731 and AND button 734 respectfully. The AND button 734 provides that same functionality as the ALL button 724; the OR button 731 provides the same functionality as the ANY button 721 as described above in connection with FIG. 7A.

FIG. 7C depicts an example of a filter palette 605 that a user can use to select content for display based on assigned keywords. FIG. 7C depicts examples of keywords that a user can include in a Boolean search. For example, the system for editing video clips can be configured to automatically analyze the various video clips for characteristics such as shakiness. Segments of the video clip designated as having low shake, meaning that those segments can be stabilized without excessive alteration of the content, are automatically marked with the keyword “Low Shake” 740. In this example, 3 minutes and 1 second of video clip has been assigned the keyword “Low Shake” 740. Segments of video clip that have excessive shake, meaning those segments that cannot be stabilized without excessive alteration of the content, are automatically assigned the keyword “Excessive Shake” 743. In this example, 48 seconds of video clip is assigned the keyword “Excessive Shake” 743. Other examples include the keywords “Indoor” 746 and “Landscape” 747. The keyword “Indoor” 746 can indicate segments taken indoor whereas “Landscape” 747 can indicate segments taken outdoors. The user can also select the keywords “Good” 750 and “Bad” 753 for segments of video clip. Other characteristics, either subjective or objective, can be determined automatically and, in either case, can be used as keywords for filtering.

In one example, a user may want to see all of the good segments taken of landscapes that are not excessively shaky. In such a case, the user can select the ALL button 724, the INCLUDE button for the “Good” keyword 750, the INCLUDE button for the “Landscape” keyword 747 and the EXCLUDE button for the “Excessive Shake” keyword 743. In another example, the user may wish to perform stabilization editing on all of the segments that are assigned the keyword “Low Shake” 740. In such a case, the user can select the INCLUDE button for the keyword “Low Shake” 740. Only those segments assigned the keyword “Low Shake” 740 are displayed while the remaining footage is hidden.

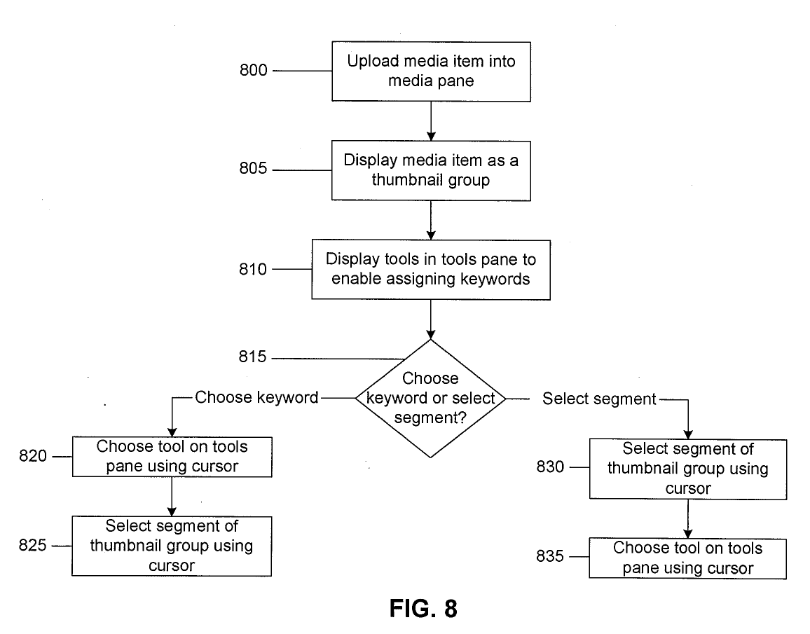

FIG. 8 is a flowchart depicting an example of assigning a keyword to segments of video clips. The media item can be uploaded into a media pane on a user interface at 800. The media item can include a video clip or a photograph. The media item can be displayed as a thumbnail group at 805 where a thumbnail group can include one or more thumbnails. The thumbnail group can represent the media item. Tools that enable assigning keywords can be displayed in a tools pane at 810. In some implementations, the tools in a tools pane can be configured to assign keywords to segments of the thumbnail group. As a first step, a user can choose a keyword or select a segment (815). A user can choose a tool on the tools pane using the cursor at 820. Subsequently, the user can select one or more segments of the thumbnail group using the cursor at 825. In this manner, a user can first choose keywords and then select segments to which the keywords are assigned. Alternatively, a user can first select one or more segments of the video clip using the cursor at 830. Subsequently, the user can choose a keyword using the tools on the tools pane to assign to the selected segments at 835.

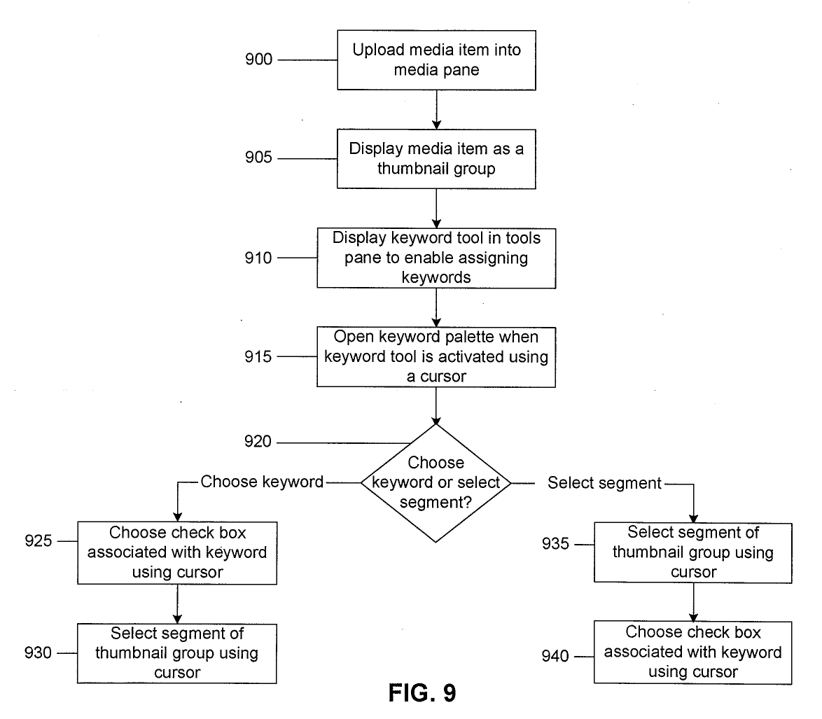

FIG. 9 depicts a flowchart of an example of assigning a keyword in a keyword palette to segments of video clips. In some implementations, several keywords can be available to be assigned to one or more segments in thumbnail groups. The keywords can be displayed in a keyword palette. The keyword palette can be displayed by activating a tool in the tools pane. The media item can be uploaded into a media pane on a user interface at 900. The media item can include a video clip, a photograph, or photographs. The media item can be displayed as a thumbnail group at 905 where a thumbnail group can include one or more thumbnails. The thumbnail group can represent the media item. A keyword tool configured to display the keyword palette upon activation can be displayed in the tools pane at 910. A user can activate the keyword tool to display the keyword palette at 915. As a first step, a user can choose a keyword or select a segment (920). A user can choose a keyword in the keyword palette by choosing the check box associated with the keyword using the cursor at 925. Subsequently, the user can select one or more segments of the thumbnail group using the cursor at 930. In this manner, a user can first choose keywords and then select segments to which the keywords are assigned. Alternatively, a user can first select one or more segments of the video clip using the cursor at 935. Subsequently, the user can choose a keyword by choosing a check box associated with the keywords in the keyword palette.

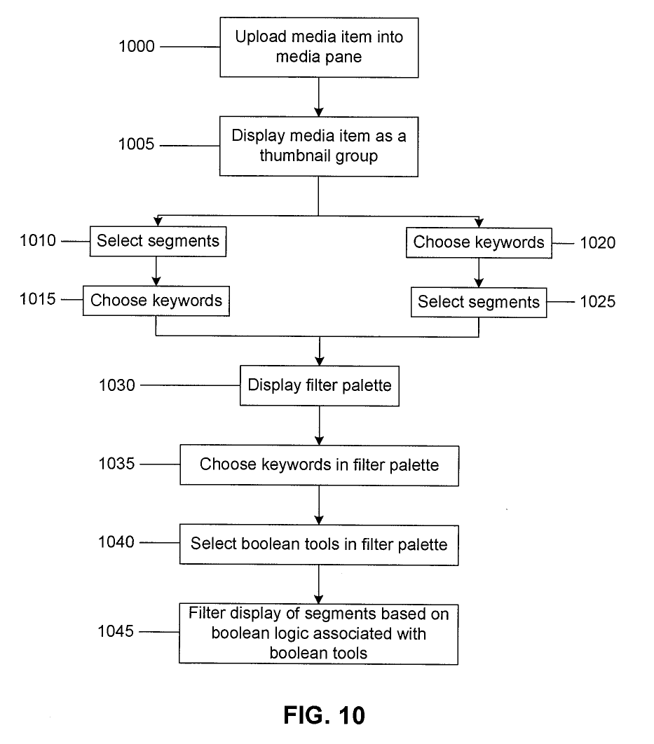

FIG. 10 depicts a flowchart of an example of filtering the display of segments of video clips based on keywords. In some implementations, the display of the segments can be filtered based on keywords assigned to the segments. The media item can be uploaded into a media pane on a user interface at 1000. The media item can include a video clip or a photograph. The media item can be displayed as a thumbnail group at 1005 where a thumbnail group can include one or more thumbnails. The thumbnail group can represent the media item. A user can select segments (910) and choose keywords (1015) to assign to the segments. Alternatively, a user can choose keywords (1020) and select segments (1025) to which the keywords can be assigned. The filter palette can be displayed 1030 by activating a tool on the user interface. In some implementations, the tool to display the filter palette can be positioned in the tools pane. The filter palette can contain all the keywords that have been assigned to the one or more segments in the thumbnail groups and the duration of the segment for which a keyword is assigned. A user can choose one or more keywords in the filter palette at 1035. A user can select Boolean tools in the filter palette at 1040. The Boolean tools can be selected by positioning the cursor over the user interface control buttons representing a Boolean tool (e.g., “AND,” “OR,” “INCLUDE,” and “EXCLUDE) and selecting the Boolean tool. Each Boolean tool can be configured to perform an editing operation based on Boolean logic. The display of the segments in the thumbnail group can be filtered for display based on the Boolean tool chosen at 1045. For example, if a user chooses “Keyword 1,” “Keyword 2,” and “AND,” only the segments assigned both “Keyword 1” and “Keyword 2” can be displayed while the remainder of the segments can be hidden from display. Alternatively, the filtered segments can be transferred to the project pane for further editing.

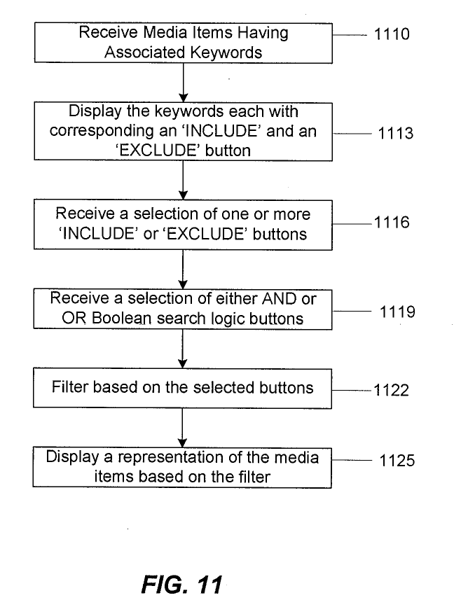

FIG. 11 depicts a flowchart of an example of filtering the display of media items based on keywords. In some implementations, the display of video clips can be filtered based on keywords assigned to the segments. At 1110, media items having associated keywords are received by the system and can be uploaded into the media pane 105 where they are displayed. In another example, a user can assign keywords to the media items. At 1113, the keywords are displayed, each with a corresponding INCLUDE and EXCLUDE button. At 1116, a selection is received of the INCLUDE or EXCLUDE button for one or more associated keywords. At 1119, the user selects either the AND or OR Boolean search logic buttons. The process, at 1122, filters the media items based on the selected Boolean search logic buttons. At 1125, the process displays a representation of the media items that are filtered. In one example, the representation includes a thumbnail of the media items. For example, if the media item is a video clip segment, the thumbnail may include a representation of the first frame of the media item. If, for example, the media item is a series of digital photographs organized chronologically using a keyword, the thumbnail can include a representation of the first photograph in the series. If, for example, the media item is a group of digital photographs organized by event using a keyword, the thumbnail can include a representation of one of the photographs in the group.

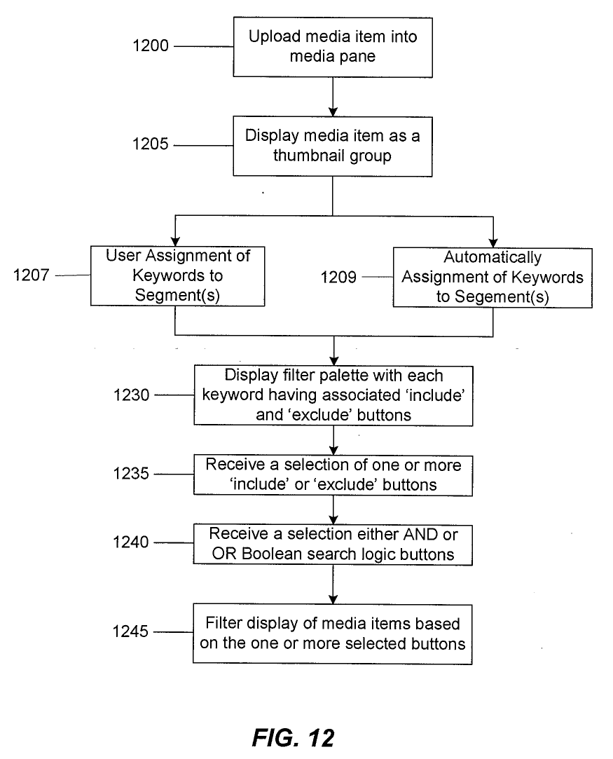

FIG. 12 depicts a flowchart of an example of filtering media items based on keywords. In some implementations, the display of the segments can be filtered based on keywords assigned to the segments. The media item can be uploaded into a media pane on a user interface at 1200. The media item can be displayed as a thumbnail group at 1205 where a thumbnail group can include one or more thumbnails. The thumbnail group can represent the media item. At 1207, the user can assign keywords manually using the keyword palette. Also, the user at 1209 also can use an editing system to automatically assign clips keywords. For example, media items can be analyzed for shakiness and excessive shakiness. Those segments that are excessively shaky are assigned a keyword such as “Excessive Shake” whereas segments that are shaky but not excessively shaky can be assigned a keyword such as “Low Shake.”

At 1230, the filter palette is displayed with each of the keywords, each keyword having an INCLUDE button and an EXCLUDE button. At 1235, the process receives a selection INCLUDE or EXCLUDE buttons for one or more keywords. The palette also has a Boolean AND button and a Boolean OR button. This Boolean AND or OR button can be depicted with ALL and ANY buttons. At 1240, a selection of either the AND or OR Boolean search logic buttons is received. At 1245 the process filters the display of the media items, such as segments, based on the one or more selected buttons.

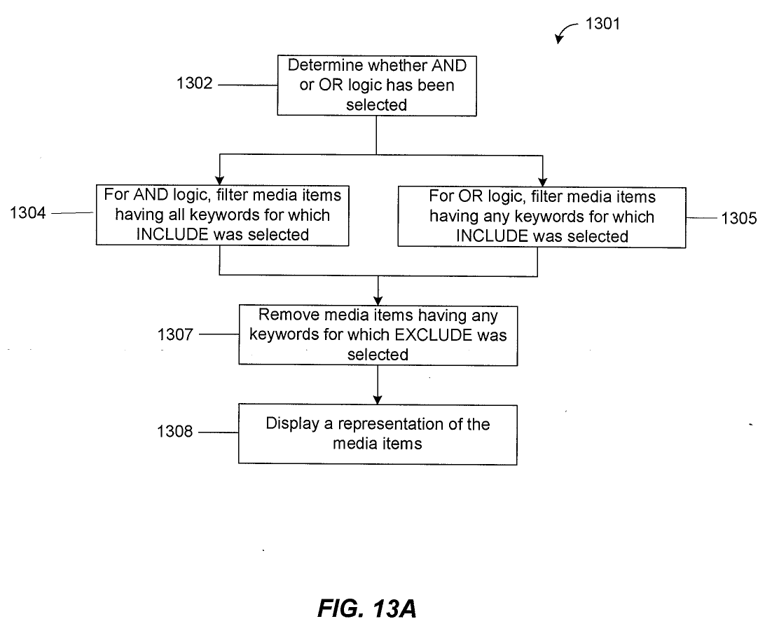

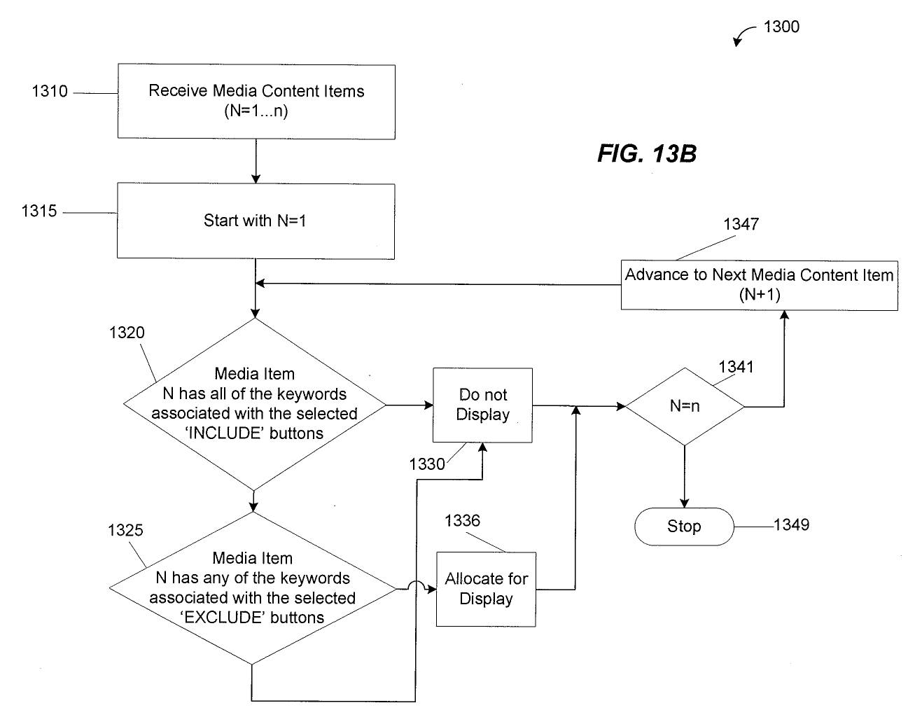

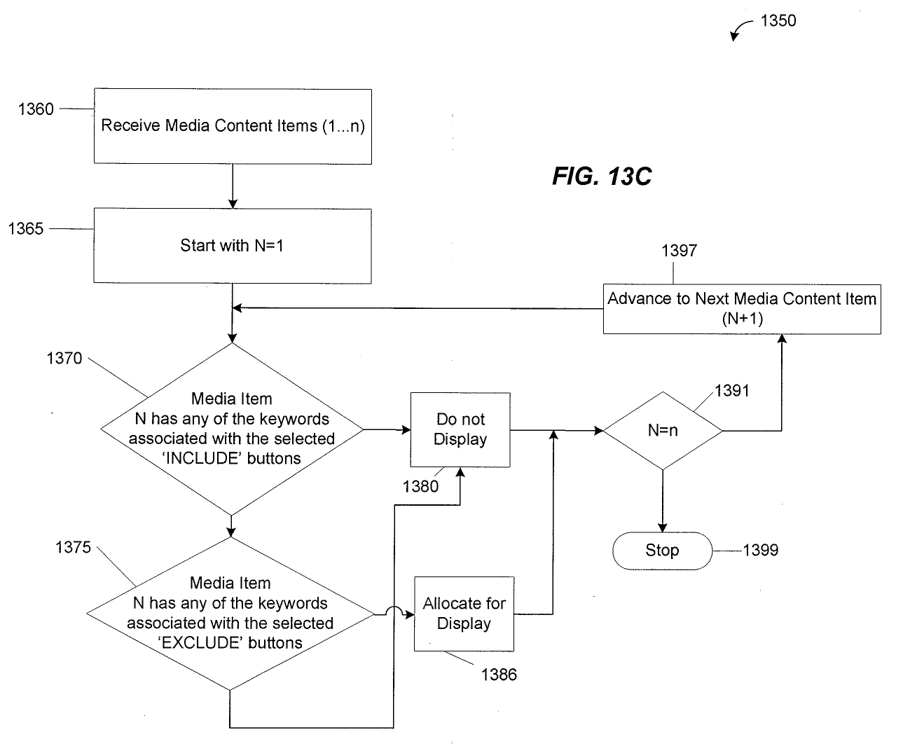

FIGS. 13A,13B, and 13C depict flowcharts of examples of filtering media items. In FIGS. 13A, 13B and 13C, one or more INCLUDE and/or EXCLUDE buttons is selected for one or more keywords from the filter palette. FIG. 13A, for example, depicts a filtering process 1301 for filtering media items with associated keywords when either the Boolean search logic AND button (ALL button) or the OR button (ANY button) is selected. At 1302, the process 1301 determines whether the AND button or the OR button has been selected. If the AND button is selected, then the process 1301 at 1304 filters the media items having all of the keywords for which INCLUDE was selected. If the OR button is selected, the process 1301 at 1305 filters the media items having any keywords for which INCLUDE was selected. Once the process 1301 filters the media items at either 1304 or 1305, the process at 1307 removes media items having any of the keywords for which EXCLUDE was selected. At 1308, the process 1301 displays the filtered media items. In one example, the process displays the filtered media items, such as segments of a video clip, while hiding the segments of the video clip not filtered.

FIG. 13B for example, depicts a filtering process 1300 for filtering media items with associated keywords when the Boolean search logic AND button (ALL button) is selected. At 1310, the process receives media items numbered N=1 . . . n. At 1315, the process starts with media item number N=1. At 1320, the process 1300 determines if the media item N has all of the keywords associated with the selected INCLUDE buttons. If not, then media item N is not allocated for display at 1330. If so, then the process determines whether media item N has any of the keywords associated with the selected EXCLUDE buttons. If so, then media item N is not allocated for display at 1330. If not, then media item N is allocated for display at 1336. The process then determines if N=n. If not, then the process advances N by 1 and repeats steps 1320 through 1341. When N=n then all of the media items have been analyzed and the filtering process 1300 stops at 1349.

FIG. 13C, for example, depicts a filtering process 1350 for filtering media items with associated keywords when the Boolean search logic OR button (ANY button) is selected. At 1360, the process receives media items numbered N=1 . . . n. At 1365, the process starts with media item number N=1. At 1370, the process 1350 determines if the media item N has any of the keywords associated with the selected INCLUDE buttons. If not, then media item N is not allocated for display at 1380. If so, then the process determines whether media item N has any of the keywords associated with the selected EXCLUDE buttons. If so then media item N is not allocated for display at 1380. If not, then media item N is allocated for display at 1386. The process then determines if N=n. If not, then the process advances N by 1 and repeats steps 1370 through 1391. When N=n then all of the media items have been analyzed and the filtering process 1350 stops at 1399.

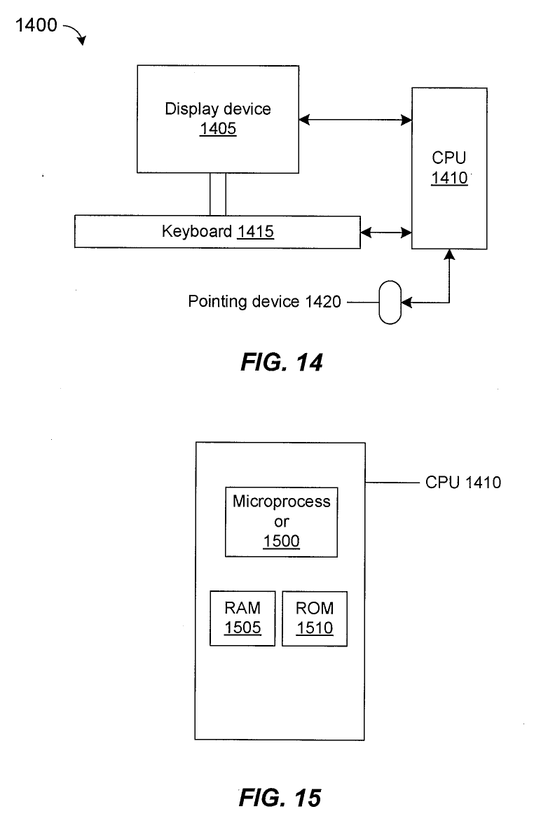

FIG. 14 depicts an example of a schematic of a system in which the video editing software is implemented. The system 1400 includes a display device 1405, a central processing unit (CPU) 1410, a key board 1415, and a pointing device 1420. The software can be implemented in virtually any suitable system 1400 (e.g., desktop computer, laptop computer, personal digital assistant (PDA), smartphone, work station). Information can be displayed to a user using any suitable display device 1405 including a cathode ray tube (CRT) and liquid crystal display (LCD) monitor. A user can use a key board 1415 and virtually any suitable pointing device 1420 (e.g., mouse, track ball, stylus, touch screen) to interact with the video editing software. In addition, a user can also use a near-contact screen to interact with the video editing software. For example, the user interface 100 can include a proximity detection mechanism that can detect the presence of an input device, such a user's finger, without requiring contact with the surface on which the user interface 100 is displayed. The display device 1405, the key board 1415, and the pointing device 1420 can be operatively coupled with the CPU 1410 through wired or wireless means.

In some implementations, the software can be installed on a CPU 1410 controlled by an operating system such as Macintosh Operating System (Mac OS) X v10.0. In other implementations, the software can be installed on a CPU 1410 controlled by other operating systems including Microsoft Windows, UNIX, and Linux. In some implementations, the system 1400 is a stand alone device such as a desktop computer. In other implementations, the system 1400 is a network where the software is installed in a centralized server and a user can access the software through one or more nodes such as work stations.

FIG. 15 depicts an example of a schematic of a central processing unit 1410. The CPU 1410 includes a microprocessor 1500, a random access memory (RAM) 1505, and a read only memory (ROM) 1510. When a user runs the video editing software application installed on a system 1400, the user provides instructions to the CPU 1410 using one or more of the input devices including the keyboard 1415 and the pointing device 1420. The microprocessor 1500 performs the operations specified by the user based on user input and instructions from RAM 1505 or ROM 1510 or both. The system 1400 displays the output on the display device 1405. In addition, the CPU 1410 can include a storage device to store content including raw footage recorded using the recording instrument, edited video, and additional content. In some implementations, the storage device resides in the CPU 1410. In other implementations, the storage devices resides external to the CPU 1410. In other implementations, the storage device resides in the recording instrument. The recording instrument is operatively coupled to the CPU 1410 through wired or wireless means to retrieve stored content.

Although a few implementations have been described here, other modifications are possible. For example, the video editing software can be embedded into the recording instrument. The display device on which the recorded content is played back can be used to display the user interface 100 including the media pane 105, the project pane 110, and the preview pane 115. A user can use a pointing device 1420 including a stylus and a touch screen to scrub across thumbnails in the media pane 105, select segments of video from the thumbnails in the media pane and 105 and transfer the selected segments to the project pane 110. Preview of the content in the thumbnail groups 210 displayed in the media pane 105 or the segments of video content in the project pane 110 or both can be viewed in the preview pane 115.

In some implementations, more than one user interface 100 can be opened and viewed simultaneously. For example, video clips 200 in a first video library can be uploaded into a first media pane 105 in a first user interface 100. Video clips in a second video library can be uploaded into a second media pane 105 in a second user interface 100. The same keyword can be assigned to segments of video clips 200 in the first video library as well as segments of video clips 200 in the second library. For example, a user can activate the check button 405, select segments of video clips in the first video library, switch the display to the second user interface, select segments of video clips in the second video library, and deactivate the check button 405.

When keywords are assigned to segments of video clips and the video clips are filtered based on the assigned keywords, the display of video clips in the media pane 105 may remain unaltered. The filtered segments of the video clips may be displayed in the project pane 110. Subsequently, the segments of the video clips can be saved as a project. In some implementations, the keywords assigned to the segments can also be saved in the project. Thus, when a user accesses a saved project, the keywords that were assigned to the segments of the project can be determined. Alternatively, subsequent to filtering, the keywords can be dissociated from the segments of video clips. If the segments of video clips are stored as a project, the video clip can be keyword free. In other implementations, when keyword assigned segments of video clips are stored, the user may be prompted to store the keywords with related segments.

Keywords can be assigned to video clips displayed in any pane on the user interface 100. For example, a user can transfer segments of video clips from the media pane 105 to the project pane 110. Subsequently, the user can open the keyword palette 510 and assign keywords to segments of video clips displayed in both the media pane 105 and the project pane 110. Similarly, filters can be applied to segments of video clips displayed in both the media pane 105 and the project pane 110.

In some implementations, two or more segments belonging to the same video content can be assigned the same keyword. In addition, segments belonging to different video clips can be assigned the same keyword. When the video clip display is filtered to display segments that are assigned the same keyword, segments belonging to the same video clip can be displayed as a continuous sequence of thumbnails, while segments belonging to different video clips can be displayed as separated by a distance. Such display can occur either in the media pane 105 or in the project pane 110 based on user input. Alternatively, all segments assigned the same keyword can be displayed continuously regardless of the video clip to which the segment belongs.

In some implementations, when the display of video clips is filtered based on more than one keyword, segments of video clips can be arranged based on the video clip to which the segments belong. For example, a first segment of a first video clip can be assigned “Keyword 1,” a second segment of the first video clip can be assigned “Keyword 2,” and a first segment of a second video clip can be assigned “Keyword 1.” If the video clips are filtered to display segments of video clips assigned “Keyword 1” or “Keyword 2,” the first and second segments of the first video clip can be displayed as a continuous sequence. The first segment of the second video clip can be displayed adjacent to the sequence. In an alternate implementation, segments of video clips assigned the same keyword can be displayed continuously. Thus, in the above example, the first segments of the first and second video clip can be displayed as a continuous sequence, while the second segment of the first video clip can be displayed adjacent to the sequence. In this manner, segments of video clips that are filtered based on assigned keywords can be arranged either based on keywords or based on the video clip to which the segments belong.

In some implementations, the system can compare the content (video and/or audio) of frames to identify regions of similar content. For example, the system can identify segments of video content where the backgrounds have the same color. The system can assign the color as a keyword to the identified segments. In another example, the system can identify segments of audio content where the volume is loud. The system can assign “Loud” as a keyword to the identified segments. The keyword assigned to segments identified by the system can be displayed in the keyword palette during editing. The keyword assigned to the segments can be altered based on user input. Segments of video can be added to or removed from the segments identified by the system.

The editing software can be used to edit photographs. Photographs can be uploaded into a user interface from a storage device, e.g., the camera used to capture the photographs. Each photograph can be displayed as a thumbnail. In addition, an album containing one or more photographs can also be displayed as thumbnails. A user can categorize photographs into, for example, good photographs and bad photographs using the check button 405 and the cross button 410, respectively. The system can compare contents of photographs and assign keywords to content. A keyword palette can be displayed to add keywords. A filter palette can be used to filter the display of photographs based on assigned keywords. In this manner, new albums can be created from uploaded photographs. Similarly, the editing software can be used to edit music files such as mp3 files, wav files, and the like. Accordingly, other embodiments are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method comprising:
displaying a plurality of keywords, each keyword being associated with one or more media items and a Boolean operation tool comprising an inclusion selector and an exclusion selector;
receiving a selection of either the inclusion selector or the exclusion selector for one or more of the associated keywords;
filtering the media items based on the one or more selected selectors; and
displaying the filtered media items.

2. The method of claim 1, further comprising:
displaying a Boolean AND operation selector;
receiving a selection of the Boolean AND operation selector; and
wherein the filtering comprises allocating the media items for display that have all the keywords for which the inclusion selector is selected.

3. The method of claim 1, further comprising:
displaying a Boolean OR operation selector;
receiving a selection of the Boolean OR operation selector; and
wherein the filtering comprises allocating the media items for display that have any of the keywords for which the inclusion selector is selected.

4. The method of claim 1, wherein filtering comprises excluding from display any of the media items that have any of the keywords for which the exclusion selector is selected.

5. The method of claim 1, wherein the displaying the filtered media items comprises displaying a thumbnail.

6. The method of claim 1, wherein the media items comprise segments of a video clip.

7. The method of claim 6, wherein the displaying the filtered media items comprises displaying thumbnails of the segments and hiding the filtered-out segments.

8. The method of claim 7, further comprising enabling a user to add one or more of the filtered segments to a project pane.

9. The method of claim 6, further comprising:
determining which segments are shaky; and
automatically assigning a keyword to the shaky segments.

10. The method of claim 9, wherein the determining which segments are shaky comprises determining which segments have excessive shake and which segments have low shake.

11. The method of claim 1, wherein one or more of media items comprise a digital still image.

12. The method of claim 1, wherein one of the keywords is associated with more than one of the media items.

13. The method of claim 1, wherein one of the media items has multiple associated keywords.

14. A computer program product, embodied on a computer-readable medium, operable to cause a data processing apparatus to perform operations comprising:
displaying a plurality of keywords, each keyword being associated with one or more media items and a Boolean operation tool comprising an inclusion selector and an exclusion selector;
receiving a selection of either the inclusion selector or the exclusion selector for one or more of the associated keywords;
filtering the media items based on the one or more selected selectors; and
displaying the filtered media items.

15. The computer program product of claim 14, further operable to cause a data processing apparatus to perform operations comprising:
displaying a Boolean AND operation selector;
receiving a selection of the Boolean AND operation selector; and
wherein the filtering comprises allocating the media items for display that have all the keywords for which the inclusion selector is selected.

16. The computer program product of claim 14, further operable to cause a data processing apparatus to perform operations comprising:
displaying a Boolean OR operation selector;
receiving a selection of the Boolean OR operation selector; and
wherein the filtering comprises allocating the media items for display that have any of the keywords for which the inclusion selector is selected.

17. The computer program product of claim 14, wherein filtering comprises excluding from display any of the media items that have any of the keywords for which the exclusion selector is selected.

18. The computer program product of claim 14, wherein the displaying the filtered media items comprises displaying a thumbnail.

19. The computer program product of claim 14, wherein the media items comprise segments of a video clip.

20. The computer program product of claim 19, wherein the displaying the filtered media items comprises displaying thumbnails of the segments and hiding the filtered-out segments.

21. The computer program product of claim 20, further operable to cause a data processing apparatus to perform operations comprising enabling a user to add one or more of the filtered segments to a project pane.

22. The computer program product of claim 19, further operable to cause a data processing apparatus to perform operations comprising:
determining which segments are shaky; and
automatically assigning a keyword to the shaky segments.

23. The computer program product of claim 22, wherein the determining which segments are shaky comprises determining which segments have excessive shake and which segments have low shake.

24. The computer program product of claim 14, wherein one or more of media items comprise a digital still image.

25. The computer program product of claim 14, wherein one of the keywords is associated with more than one of the media items.

26. The computer program product of claim 14, wherein one of the media items has multiple associated keywords.

27. A system comprising:
computer-readable medium configured to store one or more media items;
a display;
a user-interface device configured to receive input from a user; and
processor electronics configured to perform the functions comprising:
displaying on the display a plurality of keywords, each keyword being associated with the one or more media items and a Boolean operation tool comprising an inclusion selector and an exclusion selector;
receiving from the user-interface device a selection of either the inclusion selector or the exclusion selector for one or more of the associated keywords;
filtering the media items based on the one or more selected selectors; and
displaying on the display the filtered media items.

28. The system of claim 27, wherein the processor electronics are further configured to perform the functions comprising:
displaying on the display a Boolean AND operation selector;
receiving from the user interface device a selection of the Boolean AND operation selector; and
wherein the filtering comprises allocating the media items for display that have all the keywords for which the inclusion selector is selected.

29. The system of claim 27, wherein the processor electronics are further configured to perform the functions comprising:
displaying on the display a Boolean OR operation selector;
receiving from the user interface device a selection of the Boolean OR operation selector; and
wherein the filtering comprises allocating the media items for display that have any of the keywords for which the inclusion selector is selected.

30. The system of claim 27, wherein the displaying the filtered media items comprises displaying a thumbnail.

31. The system of claim 27, wherein the media items comprise segments of a video clip.

32. The system of claim 31, wherein the displaying the filtered media items comprises displaying thumbnails of the segments and hiding the filtered-out segments.

33. The system of claim 32, wherein the processor electronics are further configured to perform the function comprising enabling a user to add one or more of the filtered segments to a project pane.

34. The system of claim 31, wherein the processor electronics are further configured to perform the functions comprising:
determining which segments are shaky; and
automatically assigning a keyword to the shaky segments.

35. The system of claim 34, wherein the determining which segments are shaky comprises determining which segments have excessive shake and which segments have low shake.

36. The system of claim 27, wherein one or more of media items comprise a digital still image.

37. The system of claim 27, wherein one of the keywords is associated with more than one of the media items.

38. The system of claim 27, wherein one of the keywords is associated with more than one of the media items.
